(19) United States
(12) Patent Application Publication
(10) Pub. No.: US 2004/0049513 A1
(43) Pub. Date: Mar. 11, 2004

(54) Techniques for moving stub files without recalling data

(75) Inventors: Rony Yakir, Mountain View, CA (US); Matthew J. Foley, Santa Clara, CA (US); Yuedong Mu, san jose, CA (US); Albert Leung, Los Altos, CA (US); Nam Le, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Arkivio, Inc., Mountain View, CA

(21) Appl. No.: 10/650,171

(22) Filed: Aug. 27, 2003

Related U.S. Application Data
(60) Provisional application No. 60/407,383, filed on Aug. 30, 2002.

(51) Int. Cl. G06F 7/00

(52) U.S. Cl. 707/100

(57) ABSTRACT

Techniques for moving a stub file (or any information that is used to recall migrated data) from an originating storage location to a destination storage location without recalling the migrated data corresponding to the stub file. The originating storage location and the destination storage location may be on storage unit allocated to the same server or allocated to different servers.

### CROSS-REFERENCES TO RELATED APPLICATIONS

The present application claims priority from and is a non-provisional application of U.S. Provisional Application No. 60/407,383, filed Aug. 30, 2002 (Attorney Docket No. 21154-7US), the entire contents of which are herein incorporated by reference for all purposes:

### BACKGROUND OF THE INVENTION

The present invention relates generally to the field of data storage and management, and more particularly to techniques for reducing recalls performed by storage management applications such as Hierarchical Storage Management (HSM) applications.

In a typical storage environment comprising multiple servers coupled to one or more storage units, an administrator administering the environment has to perform several tasks to ensure availability and efficient accessibility of data. Traditionally, these tasks were performed manually by the storage administrator.

More recently, applications are available that attempt to automate some of the manual tasks. For example, Hierarchical Storage Management (HSM) applications are used to migrate data among a hierarchy of storage devices. For example, files may be migrated from online storage to near-online storage, from near-online storage to offline storage, and the like, to manage storage utilization. When a file is migrated from its original storage location to another storage location (referred to as the “repository storage location”), a stub file or tag file is left in place of the migrated file in the original storage location. The stub file comprises information that allows the HSM application to locate the migrated data in the repository storage location. The stub file may also contain attributes or metadata of the migrated file. The stub file can contain a file name or file identifier that allows the management system to find the necessary information (from a database or from the stub file itself) to recall the file. The stub file serves as an entity in the file system that is visible to the user at the original location through which the user can access the original file. The migrated file may be remigrated from the repository storage location to another repository storage location. The stub file information is updated to point to the location of the migrated or remigrated data. The stub file thus stores information that can be used to locate the migrated data. In certain embodiments, the information that is used to locate the migrated file may also be stored in a database rather than in the stub file, or in addition to the stub file.

By using a stub file, the migration of the data is made transparent to the users of the data. Users and applications can access the migrated file as though the file was still stored in the original storage location. When a HSM application receives a request to access the migrated file, the HSM application determines the repository storage location of the migrated data using information stored in the stub file and recalls (or demigrates) the requested data file from the repository storage location back to the original storage location. Recall operations incur several overheads such as increased network traffic, and also use up storage space on the storage unit comprising the original storage location where the recalled data has to be stored.

Another disadvantage of HSM-like applications is that a recall operation is performed even when the stub file itself is moved from the original storage location. For example, an administrator may want to permanently move stub files from their present location (e.g., in the original storage location) to some other storage location (referred to as the “destination storage location”). This may be needed for several reasons including to relieve capacity shortage problems on the storage unit where the stub files are stored, to reorganize data when deploying new servers and storage devices, etc. When a user moves a stub file from its present location to a new destination storage location, conventional HSM applications always recall the file data corresponding to the stub file from the repository storage location to the original storage location and then the whole file is moved to the destination storage location. This is followed by migration of the file data from the destination storage location back to the repository storage location. This is done regardless of whether the stub file is moved to a different directory or volume on the same server or on a different server.

Accordingly, by recalling data when moving a stub file, conventional HSM applications introduce unnecessary network traffic and congestion. For example, the same data is transferred on the network up to three times: (i) data is recalled from the repository storage location to the original storage location; (ii) the file is then moved from the original storage location to the destination storage location; and finally (iii) the data is migrated from the new destination storage location back to repository storage location. Additionally, storage space is required on the storage unit on which the original storage location is located and on the storage unit on which the destination storage location is located for storing the recalled data. This may be problematic if the storage units are experiencing a storage capacity problem.

In light of the above, improved techniques are needed that do not suffer from the disadvantages described above.

### BRIEF SUMMARY OF THE INVENTION

Embodiments of the present invention provide techniques for moving a stub file (or any information that is used to recall migrated data) from an originating storage location to a destination storage location without recalling the migrated data corresponding to the stub file. The originating storage location and the destination storage location may be on storage unit allocated to the same server or allocated to different servers.

According to an embodiment of the present invention, in a storage environment wherein file data is stored in a first storage location, first data locator information that can be used to identify the location of the file data is stored in a second storage location distinct from the first storage location, techniques are provided for moving the first data locator information from the second storage location to a third storage location distinct from the second storage location. Second data locator information is generated in the third storage location without recalling the file data. The second data locator is generated based upon the first data locator information such that the file data can be recalled using the second data locator information. Recall of the file data using the second data locator information is enabled. The first data locator information from the second storage location is deleted without recalling the file data.

In a storage environment wherein migrated data is stored in a first storage location, a first stub file corresponding to the migrated data is stored in a second storage location, the stub file storing information that can be used to determine the location of the migrated data, techniques are provided for changing the location of the stub file to a third storage location. A second stub file is generated in the third storage location without recalling the migrated data. The second stub file is generated based upon information from the first stub file, wherein the migrated data can be recalled using the second stub file. The first stub file is deleted from the second storage location.

The foregoing, together with other features, embodiments, and advantages of the present invention, will become more apparent when referring to the following specification, claims, and accompanying drawings.

### BRIEF DESCRIPTION OF THE DRAWINGS

FIG. 1 is a simplified block diagram of a storage environment that may incorporate an embodiment of the present invention;

FIG. 2 is a simplified block diagram of a server that provides storage management services according to an embodiment of the present invention;

FIG. 3 is a simplified high-level flowchart depicting a method of moving a stub file from an originating storage location to a destination storage location according to an embodiment of the present invention where the originating server is the same is the destination server; and

FIGS. 4A and 4B depict a simplified high-level flowchart 400 showing a method of moving a stub file from an originating storage location to a destination storage location according to an embodiment of the present invention where the originating server is different from the destination server.

### DETAILED DESCRIPTION OF THE INVENTION

In the following description, for the purposes of explanation, specific details are set forth in order to provide a thorough understanding of the invention. However, it will be apparent that the invention may be practiced without these specific details.

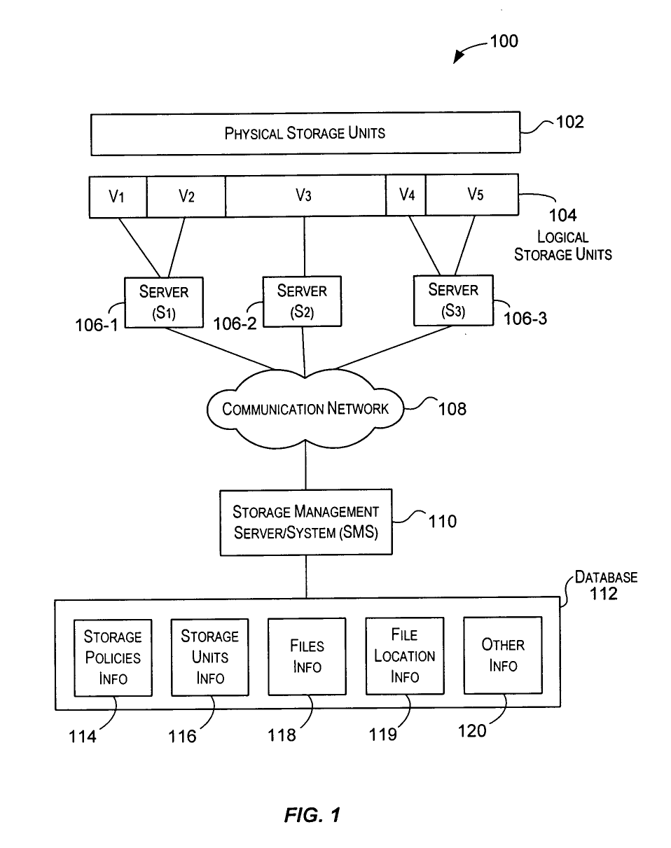

FIG. 1 is a simplified block diagram of a storage environment 100 that may incorporate an embodiment of the present invention. Storage environment 100 depicted in FIG. 1 is merely illustrative of an embodiment incorporating the present invention and does not limit the scope of the invention as recited in the claims. One of ordinary skill in the art would recognize other variations, modifications, and alternatives.

As depicted in FIG. 1, storage environment 100 comprises a plurality of physical storage devices 102 for storing data. Physical storage devices 102 may include disk drives, tapes, hard drives, optical disks, RAID storage structures, solid state storage devices, SAN storage devices, NAS storage devices, and other types of devices and storage media capable of storing data. The term “physical storage unit” is intended to refer to any physical device, system, etc. that is capable of storing information or data.

Physical storage units 102 may be organized into one or more logical storage units/devices 104 that provide a logical view of underlying disks provided by physical storage units 102. Each logical storage unit (e.g., a volume) is generally identifiable by a unique identifier (e.g., a number, name, etc.) that may be specified by the administrator. A single physical storage unit may be divided into several separately identifiable logical storage units. A single logical storage unit may span storage space provided by multiple physical storage units 102. A logical storage unit may reside on non-contiguous physical partitions. By using logical storage units, the physical storage units and the distribution of data across the physical storage units becomes transparent to servers and applications. For purposes of description and as depicted in FIG. 1, logical storage units 104 are considered to be in the form of volumes. However, other types of logical storage units are also within the scope of the present invention. The term “storage unit” is intended to refer to a physical storage unit (e.g., a disk) or a logical storage unit (e.g., a volume).

Storage environment 100 also comprises several servers 106. Servers 106 maybe data processing systems that are configured to provide a service. One or more volumes from logical storage units 104 may be assigned or allocated to servers 106. For example, as depicted in FIG. 1, volumes V1 and V2 are assigned to server (S1) 106-1, volume V3 is assigned to server (S2) 106-2, and volumes V4 and V5 are assigned to server (S3) 106-3. A server 106 provides an access point for the one or more volumes allocated to that server. Servers 106 may be coupled to a communication network 108.

According to an embodiment of the present invention, a storage management server/system (SMS) 110 is coupled to server 106 via communication network 108. Communication network 108 provides a mechanism for allowing communication between SMS 110 and servers 106. Communication network 108 may be a local area network (LAN), a wide area network (WAN), a wireless network, an Intranet, the Internet, a private network, a public network, a switched network, or any other suitable communication network. Communication network 108 may comprise many interconnected computer systems and communication links. The communication links may be hardwire links, optical links, satellite or other wireless communications links, wave propagation links, or any other mechanisms for communication of information. Various communication protocols may be used to facilitate communication of information via the communication links, including TCP/IP, HTTP protocols, extensible markup language (XML), wireless application protocol (WAP), Fiber Channel protocols, protocols under development by industry standard organizations, vendor-specific protocols, customized protocols, and others.

SMS 110 is configured to provide storage management services for storage environment 100. According to an embodiment of the present invention, SMS 110 is configured to store data and provide services to enable stub files to be moved without recalling the migrated data associated with the stub files. SMS 110 stores information that tracks locations of files that are migrated (or remigrated) and recalled. The information may be stored in memory and/or disk accessible to SMS 110. For example, as shown in FIG. 1, the information may be stored in database 112. The information stored in database 112 may include information 114 related to storage policies and rules configured for the storage environment, information 116 related to the various monitored storage units, information 118 related to the files stored in the storage environment, file location information 119, and other types of information 120. File location information 119 comprises information that may be used to find location of migrated data. File location information 119 or portions thereof may also be stored on or replicated in databases on servers 106. Database 112 may be embodied in various forms including a relational database, directory services, data structure, etc. The information may be stored in various formats.

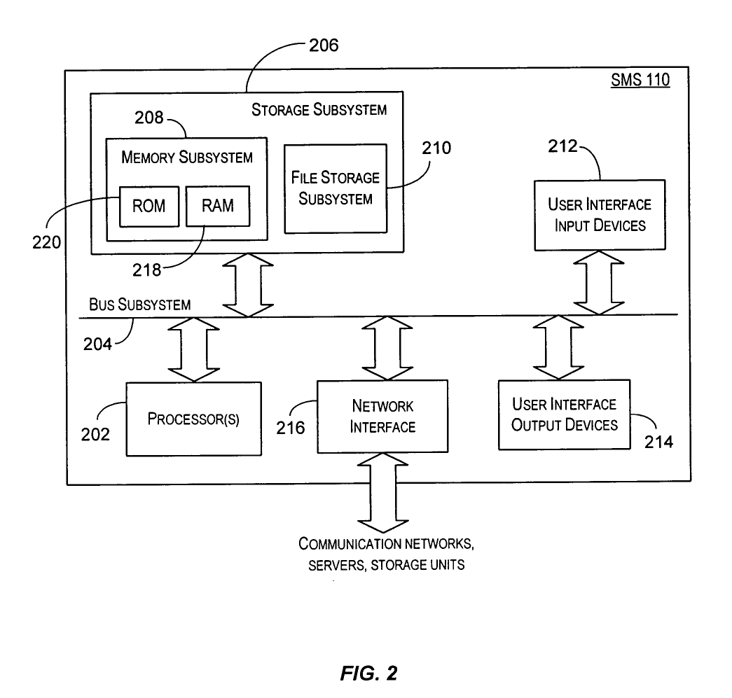

FIG. 2 is a simplified block diagram of SMS 110 according to an embodiment of the present invention. As shown in FIG. 2, SMS 110 includes a processor 202 that communicates with a number of peripheral devices via a bus subsystem 204. These peripheral devices may include a storage subsystem 206, comprising a memory subsystem 208 and a file storage subsystem 210, user interface input devices 212, user interface output devices 214, and a network interface subsystem 216. The input and output devices allow a user, such as the administrator, to interact with SMS 110.

Network interface subsystem 216 provides an interface to other computer systems, networks, servers, and storage units. Network interface subsystem 216 serves as an interface for receiving data from other sources and for transmitting data to other sources from SMS 110. Embodiments of network interface subsystem 216 include an Ethernet card, a modem (telephone, satellite, cable, ISDN, etc.), (asynchronous) digital subscriber line (DSL) units, and the like.

User interface input devices 212 may include a keyboard, pointing devices such as a mouse, trackball, touchpad, or graphics tablet, a scanner, a barcode scanner, a touchscreen incorporated into the display, audio input devices such as voice recognition systems, microphones, and other types of input devices. In general, use of the term “input device” is intended to include all possible types of devices and mechanisms for inputting information to SMS 110.

User interface output devices 214 may include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from SMS 110.

Storage subsystem 206 may be configured to store the basic programming and data constructs that provide the functionality of the present invention. For example, according to an embodiment of the present invention, software code modules implementing the functionality of the present invention may be stored in storage subsystem 206. These software modules may be executed by processor(s) 202. Storage subsystem 206 may also provide a repository for storing data used in accordance with the present invention. For example, information used for enabling stub files to be moved without performing recall may be stored in storage subsystem 206. Storage subsystem 206 may also be used as a migration repository to store data that is moved from a storage unit. Storage subsystem 206 may also be used to store data that is moved from another storage unit. Storage subsystem 206 may comprise memory subsystem 208 and file/disk storage subsystem 210.

Memory subsystem 208 may include a number of memories including a main random access memory (RAM) 218 for storage of instructions and data during program execution and a read only memory (ROM) 220 in which fixed instructions are stored. File storage subsystem 210 provides persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

Bus subsystem 204 provides a mechanism for letting the various components and subsystems of SMS 110 communicate with each other as intended. Although bus subsystem 204 is shown schematically as a single bus, alternative embodiments of the bus subsystem may utilize multiple busses.

SMS 110 can be of various types including a personal computer, a portable computer, a workstation, a network computer, a mainframe, a kiosk, or any other data processing system. Due to the ever-changing nature of computers and networks, the description of SMS 110 depicted in FIG. 2 is intended only as a specific example for purposes of illustrating the preferred embodiment of the computer system. Many other configurations having more or fewer components than the system depicted in FIG. 2 are possible.

Notations

Servers 106 and SMS 100 facilitate migration, remigration, and recall operations for files stored in storage environment 100. The following notations will be used in this application to facilitate discussion of migration and remigration operations. These notations are not intended to limit the scope of the present invention as recited in the claims.

(1) An “original storage location” is a storage location (e.g., a directory) where a data file is stored before the file is migrated.

(2) An “original volume” is a volume comprising the original storage location.

(3) An “original server” is a server to which the original volume is allocated. The original server may be configured to manage access to the original volume. An original server may be coupled to other volumes.

(4) A “repository storage location” is a storage location (e.g., a directory) where the migrated or remigrated data is stored.

(5) A “repository volume” is a volume comprising the repository storage location where migrated or remigrated data is stored.

(6) A “repository server” is a server to which the repository volume is allocated. The repository server may be configured to manage access to the repository volume.

(7) An “originating storage location” is a storage location where the stub file is presently stored and from where it is to be moved to a destination storage location. The originating storage location may be the same as or different from the original storage location.

(8) An “originating volume” is a volume comprising the original storage location from where the stub file is to be moved. The originating volume may be the same as or different from the original volume.

(9) An “originating server” is a server to which the originating volume is allocated. The originating server may be configured to regulate access to the originating volume. The originating server may be the same as or different from the destination server.

(10) A “destination storage location” is a storage location to which the stub file is to be moved from the originating storage location. The originating storage location and the destination storage location may be on the same volume or on different volumes. If on different volumes, the volumes may be allocated to the same server or to different servers.

(11) A “destination volume” is a volume comprising the destination storage location to which a stub file is to be moved. The destination volume may be the same as the originating volume or may be a different volume. The destination volume and the originating volume may be allocated to the same server or to different servers.

(12) A “destination server” is a server to which the destination volume is allocated. The destination server may be configured to regulate access to the destination volume. The destination server may be the same as or different from the originating server.

(13) A “stub file” or “tag file” is a physical file that represents a migrated file. When a file is migrated from an original storage location, the stub file is stored in the original storage to represent the migrated file. The stub file may be moved from the original file location to another location. The stub file stores information that enables a migrated file to be recalled. In one embodiment, the information stored in the physical stub file identifies the location of the migrated data. In another embodiment, the information (e.g., a file identifier or file name) stored in the stub file may be used to find file location information that is then used to locate the migrated data. The file location information may be stored in a database coupled to SMS 110, in databases coupled to one or more other servers in the storage environment, or in some other location. A stub file may also contain attributes or metadata of the migrated file. The stub file serves as an entity in the file system through which the original migrated file can be accessed.

(14) Data locator information is any information that can be used to locate the storage location of file data. For example, data locator information may correspond to information that is used to locate migrated data. The data locator information or a portion thereof may be stored in a stub file.

Migration

Migration is the process where a file data, or a portion thereof, is moved from an original storage location on an original volume to a repository storage location on a repository volume. According to an embodiment, a file migration event usually results in the following:

(1) The data portion of the file being migrated is moved from the original storage location on the original volume to a repository storage location on a repository volume. A portion of (or the entire) meta-data portion of the file may also be moved to the repository volume.

(2) A stub or tag file is left in place of the original file in the original storage location on the original volume. The stub file stores information that can be used to determine the identity of the repository storage location and the repository server. The stub file stores information that can be used to locate the migrated data. The stub file may comprise the meta-data portion of the migrated file and a file identifier for the migrated file. The stub file may also store a cache comprising a small portion of the data portion of the file. The stub file may also store information about the repository server.

(3) A unique repository identifier (referred to as the URI) is generated and saved in the stub file. According to an embodiment of the present invention, the URI is a combination of the original server identifier (e.g., machine ID for the original server) and a unique file identifier for the migrated file. The URI facilitates identification of the repository storage location for a migrated file. According to an embodiment of the present invention, the URI for a file is unique within a storage environment.

(4) The following information is also stored in a centralized location (e.g., by SMS 110) for each migrated file: (a) URI for the migrated file; (b) information identifying the original volume; (c) identifier (e.g., a machine ID) of the repository server; and (d) information identifying the repository storage location where the data is migrated.

Recall

A recall is performed when a request is received to access a migrated file. The following operations may be performed when an original server receives a request to access a migrated file:

(1) The original server identifies the repository server and the URI for the file to be recalled. The original server may identify the repository server and the URI from information stored in the stub file for the file to be recalled. Alternatively, the information may be determined from information stored by SMS 110 or other server.

(2) The original server then presents the URI for the file to be recalled to the repository server and the migrated data is then recalled from the repository volume to the original volume.

(3) State information may be stored in the stub file and by SMS 110 to indicate different file states and whether certain operations should be temporarily disallowed. For example, a status flag may be set that indicates that a file should not be remigrated when it is being recalled by the original server.

Embodiments of the present invention provide techniques for moving a stub file corresponding to a migrated data file from one storage location to another storage location without recalling the migrated data corresponding to the stub file. For purposes of discussion, two embodiments of the present invention are described in this application. A first embodiment is described wherein the stub file is moved from one storage location to another storage location on one or more volumes allocated to the same server. A second embodiment is described wherein the stub file is moved from one storage location to another storage location on volumes allocated to different servers.

First Embodiment

Techniques described in this embodiment are used for moving a stub file from an originating storage location to a destination storage location where the originating server is the same as the destination server (i.e., the originating volume and the destination volume are allocated to the same server). For example, in FIG. 1, the stub file may be moved from a storage location on volume V1 to a storage location on volume V2 that are assigned to server S1, from a location on volume V4 to a storage location on volume V5 that are assigned to server S2, etc. The techniques described in this embodiment may also be used for moving the location of the stub file from an originating storage location to a destination storage location on the same volume (e.g., moving a stub file from a first directory on a volume to another directory on the same volume). The originating storage location from where the stub file is moved may be the original storage location (e.g., if this is the first time that the stub file is being moved since migration) or may be different from the original storage location (e.g., if the stub file has been previously moved from the original storage location).

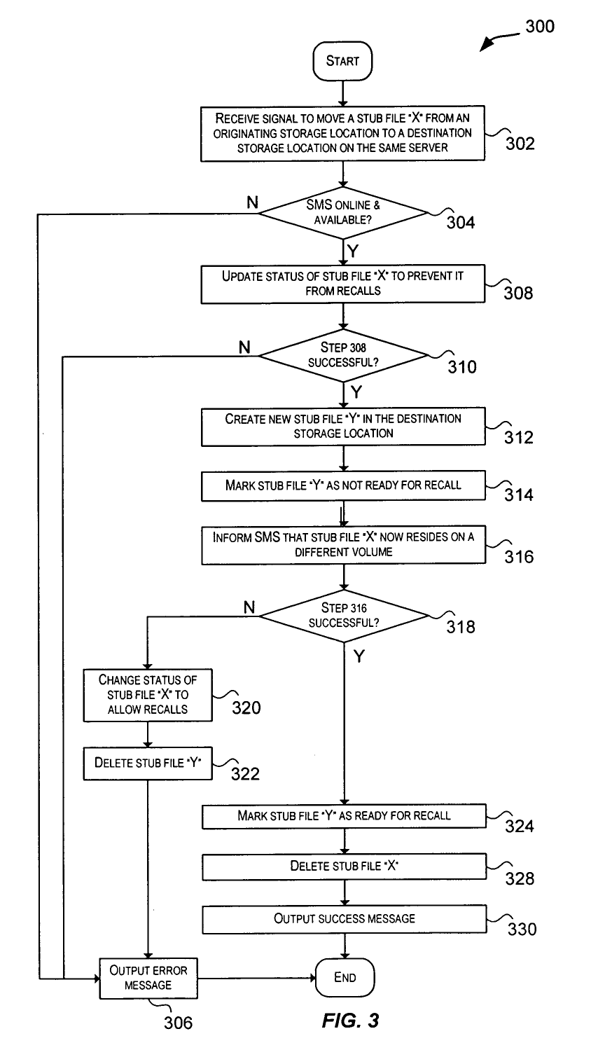

FIG. 3 is a simplified high-level flowchart 300 depicting a method of moving a stub file from an originating storage location to a destination storage location according to an embodiment of the present invention where the originating server is the same is the destination server. The method depicted in FIG. 3 may be performed by software modules executed by a processor, hardware modules, or combinations thereof. Flowchart 300 depicted in FIG. 3 is merely illustrative of an embodiment of the present invention and is not intended to limit the scope of the present invention. The processing may be performed by the originating server. Other variations, modifications, and alternatives are also within the scope of the present invention. The method depicted in FIG. 3 may be adapted to work with different implementation constraints such as security constraints, operating system constraints, and the like.

The processing is initiated when an originating server receives a signal to move a stub file “X” from an originating storage location on a originating volume to a destination storage location on a destination volume assigned to the same server (step 302). The signal may be received from a user, an application or program, or from other like source. Stub file “X” may store information for data from file “X” that has been migrated.

Originating server then verifies if SMS 110 is online and available (step 304). If SMS 110 is determined to be offline or unavailable, then an error status message is output to the source that sent the signal received in step 302 (step 306) and processing is stopped. The error message may indicate that the stub file move operation could not be completed. The error message may also identify the cause of the error.

If SMS 110 is determined to be available in step 304, then originating server updates the status of stub file “X” to prevent it from recalls (step 308). The status information may be stored in stub file “X”. A check is then made to determine if step 308 was successfully performed (310). If step 308 is determined to have failed, then processing continues with step 306 wherein an error message is output and processing is then stopped.

If step 308 is determined to have been successfully performed, then originating server creates a new stub file “Y” in the destination storage location on the destination volume (step 312). According to an embodiment of the present invention, the new stub file “Y” is created using information from stub file “X”. For example, the URI of stub file “X” and a machine identifier for repository server stored in stub file “X” may be used to create stub file “Y”. Other information related to the migrated file such as file attributes, security information, cache information, etc. that is stored in stub file “X” and not migrated may be stored in stub file “Y”. According to an embodiment of the present invention, stub file “Y” resembles stub file “X” and stores the information stored by stub file “X”. Stub file “Y” is essentially a physical file that is a duplicate of stub file “X”. Stub file “Y” may have the same or different name from that of stub file “X”. Stub file “Y” is then marked as not ready for recall (step 314).

Assuming that the destination volume is different from the originating volume, originating server then informs SMS 110 that stub file “X” now resides on a different volume (step 316). The processing in step 316 can be achieved using various techniques. According to one technique, the information may be communicated to SMS 110 using a protocol (possibly proprietary) between originating server and SMS 110. According to another technique, the originating server may modify/update information stored in a database of SMS 110 using database update techniques such as ODBC techniques. Other techniques known to those skilled in the art may also be used to inform SMS 110.

A check is then made to see if step 316 was successfully performed (step 318). If it is determined that step 316 failed, then the status of stub file “X” is changed to allow recalls (step 320). The newly created stub file “Y” is deleted (step 322). Processing then continues with step 306 wherein an error message is output indicating that the stub file move operation could not be completed. The error message may also identify the cause of the error. Processing is then stopped.

If it is determined that the processing in step 318 that step 316 was successfully completed, then the newly created stub file “Y” is marked as ready for recall (step 324). The old stub file “X” is then deleted from the originating storage location (step 328). A message may be output indicating that the stub file was successfully moved from the originating storage location to the destination storage location (step 330). Processing then ends.

As described above, the stub file is moved from the originating storage location to the destination storage location without recalling migrated data associated with the stub file. The techniques described above can be used to move stub files without recalling the migrated data in a HSM environment.

The techniques described above can be used in any environment where actual data (e.g., the migrated data) is separated from information (“data locator information”) that is used to locate the actual data. In the embodiment described above, the data locator information or a portion thereof is stored in a stub file. The data locator information or portions thereof may also be stored in various other storage locations. Moving the stub file from the originating storage location to the destination storage location essentially moves the information stored by the stub file from the originating storage location to the destination storage location. Accordingly, embodiments of the present invention provide techniques for moving the data locator information without moving the actual data.

Second Embodiment

This embodiment provides techniques for moving a stub file from an originating storage location to a destination storage location where the originating server is different from the destination server (i.e., the originating volume and the destination volume are allocated to different servers). For example, in FIG. 1, the stub file may be moved from a storage location on volume V1 allocated to server S1 to a storage location on volume V3 that is allocated to server S2, from a storage location on volume V4 allocated to server S3 to a storage location on volume V2 allocated to server S1, etc. The originating storage location from where the stub file is moved may be the original storage location (e.g., if this is the first time that the stub file is being moved since migration), or may be different from the original storage location (e.g., if the stub file has been previously moved from the original storage location).

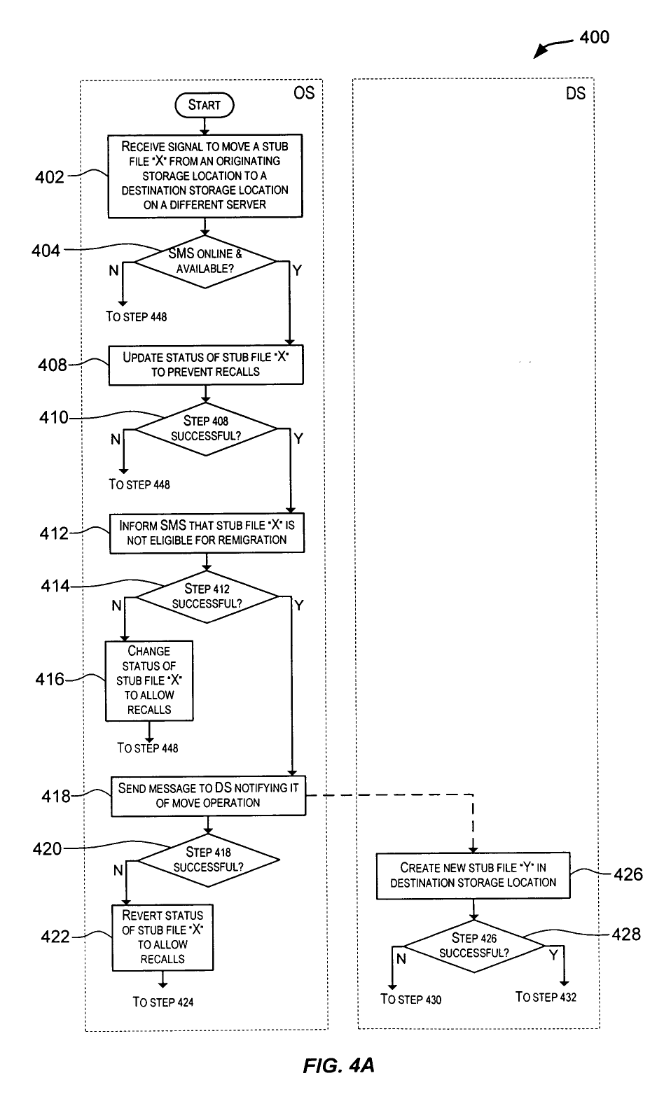

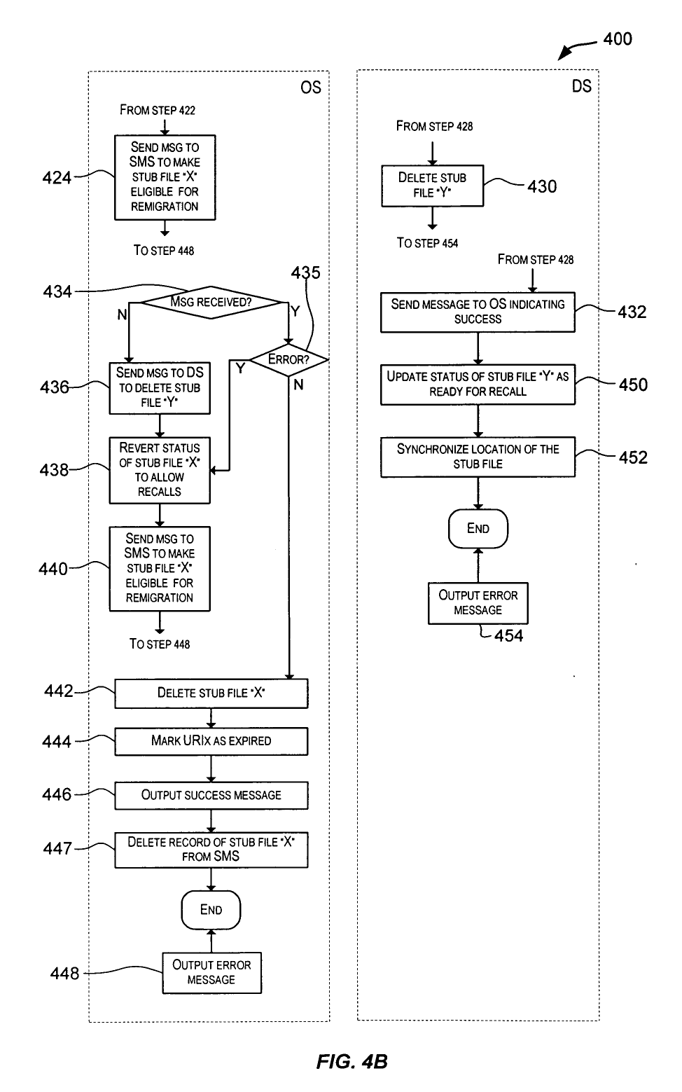

FIGS. 4A and 4B depict a simplified high-level flowchart 400 showing a method of moving a stub file from an originating storage location to a destination storage location according to an embodiment of the present invention where the originating server is different from the destination server. The method depicted in FIGS. 4A and 4B may be performed by software modules executed by a processor, hardware modules, or combinations thereof. As shown in FIGS. 4A and 4B, according to an embodiment of the present invention, the processing is performed by an originating server and a destination server. Flowchart 400 depicted in FIGS. 4A and 4B is merely illustrative of an embodiment of the present invention and is not intended to limit the scope of the present invention. Other variations, modifications, and alternatives are also within the scope of the present invention. The method depicted in FIGS. 4A and 4B may be adapted to work with different implementation constraints such as security constraints, operating system constraints, and the like.

Processing is initiated when an originating server receives a signal to move a stub file “X” from an originating storage location on an originating volume to a destination storage location on a destination volume assigned to a destination server that is different than the originating server (step 402). The signal may be received from a user, an application or program, or from other like source. Stub file “X” may store information for data from file “X” that has been migrated.

Originating server then verifies if SMS 110 and the destination server are online and available (step 404). If SMS 110 and the destination server are determined to be offline or unavailable, then an error status message is output to the source that sent the signal received in step 402 (step 448) and processing is stopped. The error message may indicate that the stub file move operation could not be completed. The error message may also identify the cause of the error.

If SMS 110 and the destination server are determined to be online and available in step 404, then originating server updates the status of stub file “X” to prevent it from recalls (step 408). The status information may be stored in stub file “X”. A check is then made to determine if step 408 was successfully performed (410). If step 408 is determined to have failed, then processing continues with step 448 wherein an error message is output and processing is then stopped.

If step 408 is determined to have been successfully performed, then the originating server informs SMS 110 that the stub file “X” is no longer eligible for remigration (step 412). This can be achieved using different techniques. According to one technique, the originating server may inform SMS 110 using a protocol (possibly proprietary) between originating server and SMS 110. According to another technique, the originating server may modify/update information stored in a database of SMS 110 using database update techniques such as ODBC techniques. Other techniques known to those skilled in the art may also be used to inform SMS 110.

A check is then made to see if step 412 was successfully performed (step 414). If it is determined that step 412 failed, then the status of stub file “X” is changed to allow future recalls (step 416). An error message may then be output per step 408 and the processing is stopped. The error message may also identify the cause of the error.

If it is determined that step 412 was successfully performed, then originating server sends a message to the destination server (DS) to notify it about the stub file move operation (step 418). The message sent to the destination server comprises information that is used to create a new stub file “Y” in the destination storage location by the destination server. The message may include: (1) the name of stub file “X”; (2) the name of stub file “Y”; (3) the URI (URI_{X}) of stub file “X”; (4) other information such as file attributes, security information, cache information, etc. related to the migrated data that is stored in stub file “X” or not migrated for file “X”. Other information may also be included in the message sent by the originating server to the destination server in step 418.

A check is then made to see if step 418 was successfully performed (step 420). If it is determined that step 418 failed, then the originating server reverts the status of stub file “X” to allow recalls (step 422). Originating server sends a message to SMS 110 to update the status of stub file “X” to be eligible for remigration (step 424). An error message may be output to the source of the signal received in step 402 indicating that the stub file move operation could not be completed according to step 448. The error message may also identify the cause of the error.

Upon receiving a message from the originating server, the destination server concurrently creates a new stub file “Y” in the destination storage location using the information received in step 418 (step 426). Stub file “Y” may have the same or different name than stub file “X”. As part of step 426, the destination server generates a new URI (URI_{Y}) for the newly created stub file “Y”. Stub file “Y” is updated to store information including: (1) information identifying the location of the migrated file data; (2) the machine identifier of the repository server; and (3) information indicating that URI_{X}, and not URI_{Y}, should be used for searching for the migrated data. Other information may also be stored. As part of step 426, the status of stub file “Y” is marked as not ready for recall.

A check is then made to determine if step 426 was successfully performed (step 428). If it is determined that step 426 failed, then destination server deletes stub file “Y” (step 430), sends an error response message to the originating server, outputs an error message per step 454, and processing is stopped. The error message may identify the cause of the error. If it is determined that step 426 succeeded, then the destination server sends a message to the originating server indicating success (step 432). The destination server then continues processing with step 450 as described below.

The originating server receives a message from the destination server that indicates the status of step 426. The originating server may not receive any message if for some reason the message could not be delivered to the originating server (e.g., if the destination server crashes before the message can be sent). If the originating server determines in step 434 that a message was not received from the destination server then originating server sends a message to the destination server to delete stub file “Y” (step 436). This is to cover the scenario where the destination server may have crashed after creating stub file “Y” but before it could send a success message to the originating server. The originating server reverts the status of stub file “X” to allow recalls (step 438). The originating server informs SMS 110 to update the status of stub file “X” to be eligible for remigration (step 440). The originating server may then send an error message to the source of the signal received in step 402 per step 448. The error message may also identify the cause of the error. Processing is then stopped.

If a message was received, then originating server determines if the message was an error message indicating error status in step 426 (step 435). If an error message was received, then originating server reverts the status of stub file “X” to allow recalls (step 438). It then informs SMS 110 to update the status of stub file “X” to be eligible for remigration (step 440). It may then send an error message to the source of the signal received in step 402 per step 448. The error message may identify the cause of the error.

If the originating server determines in step 435 that a success message was received, then the originating server deletes the stub file “X” (step 442). URI_{X} is marked as expired and not to be used (step 444). Since URI_{X} could potentially be used by stub file “Y”, in order prevent this error situation, URI_{X} is marked not to be used. Originating server sends a message to the source of the signal received in step 402 indicating success of the move operation (step 446). The originating server deletes the records of stub file “X” from the database of SMS 110 (step 447). Processing performed by the originating server then is completed.

If the destination server determines in step 428 that the processing performed in step 426 was successful, it sends a message indicating success to the originating server per step 432. The destination server then updates the status of stub file “Y” as ready for recall (step 450). The destination server can access the migrated file corresponding to stub file “Y” from its repository server using URD_{X} that it receives from the originating server in step 418. At this point, SMS 110 is not aware of the existence of stub file “Y” as yet, and stub file “X” is not eligible for remigration.

A process on the destination server (e.g., a background process) synchronizes the location of the stub file (step 452). As part of the processing in 452, a record is created on SMS 110 (e.g., in the database originating server SMS 110) with information such as (1) the current URI_{Y}, (2) the machine identifier of the repository server, (3) URI_{X} to locate the migrated file corresponding to stub file “Y”, (4) status information marking that the file data corresponding to stub file “Y” is ready for remigration. As part of step 452, the destination server is unmarked as the sole authority of where the migrated data is stored. The status of stub file “Y” is marked as eligible for remigration.

It is possible that the file corresponding to stub file “Y” may be recalled without involving SMS 110 before the processing in 452 is performed. In this case, step 452 may not be required. SMS 110 is not aware of the existence of stub file “Y” before step 452, and thus file “Y” is not selected for remigration. When SMS 110 selects file “Y” for remigration after step 452 is completed, it can change its own database and the stub file to use URI_{Y} to locate the migrated data.

As described above, the stub file is moved from a volume allocated to an originating server to a volume allocated to a destination server that is different from the originating server without recalling migrated data associated with the stub file. The techniques described above can be used to move stub files without recalling the migrated data in a HSM environment.

The techniques described above can be used in any environment where actual data (e.g., the migrated data) is separated from information (“data locator information”) that is used to locate the actual data. In the embodiment described above, the data locator information or a portion thereof is stored in a stub file. The data locator information or portions thereof may also be stored in various other storage locations. Moving the stub file from the originating storage location to the destination storage location essentially moves the information stored by the stub file from the originating storage location to the destination storage location. Accordingly, embodiments of the present invention provide techniques for moving the data locator information without moving the actual data.

As described above, the teachings of the present invention can be applied in a HSM managed storage environment where stub files can be moved without recalling the migrated data associated with the stub files. In general, the techniques described above can be used in any environment where data locator information (e.g., the stub file) is separated from the actual data (e.g., the migrated data). Techniques according to the teachings of the present invention can be used to move the data locator information without moving the actual data.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the present invention has been described using a particular series of transactions and steps, it should be apparent to those skilled in the art that the scope of the present invention is not limited to the described series of transactions and steps.

Labels such as “tag file”, “stub file”, “originating server”, “destination server”, etc. are used only to illustrate the teachings of the present invention and are not meant to limit the scope of the present invention as recited in the claims. For example, the terms “tag file” and “stub file” are intended to refer to any file that stores data locator information or a portion thereof that is used to locate data that is stored in a storage location different from the storage location of the data locator information.

Further, while the present invention has been described using a particular combination of hardware and software, it should be recognized that other combinations of hardware and software are also within the scope of the present invention. The present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. In a storage environment wherein file data is stored in a first storage location, first data locator information that can be used to identify the location of the file data is stored in a second storage location distinct from the first storage location, a method of moving the first data locator information from the second storage location to a third storage location distinct from the second storage location, the method comprising:
generating second data locator information in the third storage location, the second data locator generated based upon the first data locator information such that the file data can be recalled using the second data locator information;
enabling recall of the file data using the second data locator information; and
deleting the first data locator information from the second storage location, wherein the generating, enabling, and deleting are performed without recalling the file data from the first storage location.

2. The method of claim 1 further comprising disabling recall of the file data using the first data locator information prior to generating the second data locator information.

3. The method of claim 1 wherein the second storage location is on a storage unit allocated to a first server and the third storage location is on a storage unit allocated to the first server.

4. The method of claim 3 further comprising:
providing first information indicating that the file data can be recalled using the first data locator information stored in the second storage location
wherein generating the second data locator information comprises updating the first information to indicate that the file data can be recalled using the second data locator information stored in the third storage location.

5. The method of claim 4 wherein:
generating the second data locator further comprises determining if the first information was updated; and
enabling recall of the file data using the second data locator information only if it is determined that the first information was updated.

6. The method of claim 1 wherein the second storage location is on a storage unit allocated to a first server and the third storage location is on a storage unit allocated to a second server distinct from the first server.

7. The method of claim 6 wherein generating the second data locator information comprises:
disabling recall of the file data using the first data locator information prior to generating the second data locator information;
communicating a first message from the first server to the second server, the message comprising information related to the first data locator information; and
wherein the second data locator information is generated by the second server using the information in the first message.

8. The method of claim 7 wherein the first message comprises a portion of the first data locator information, the portion including an identifier indicative of the first storage location where the file data is stored.

9. The method of claim 7 further comprising:
communicating a second message from the second server to the first server indicating generation of the second data locator information by the second server;
wherein deleting the first file locator information comprises deleting the first file locator information upon receiving the message from the second server.

10. The method of claim 1 wherein the storage environment is managed by a hierarchical storage management (HSM) application, the file data represents migrated data, the first data locator information is stored in a first stub file, and the second data locator information is stored in a second stub file.

11. In a storage environment wherein migrated data is stored in a first storage location, a first stub file corresponding to the migrated data is stored in a second storage location, the first stub file storing information that can be used to determine the location of the migrated data, a method of changing the location of the stub file to a third storage location, the method comprising:
generating a second stub file in the third storage location, the second stub file generated based upon information from the first stub file, wherein the migrated data can be recalled using the second stub file; and
deleting the first stub file from the second storage location;
wherein the generating and deleting are performed without recalling the migrated data from the first storage location.

12. The method of claim 11 wherein the second storage location is on a storage unit allocated to a first server and the third storage location is on a storage unit allocated to the first server.

13. The method of claim 12 further comprising providing a database storing first information indicative of the storage location of a stub file for the migrated data, wherein generating the second stub file comprises:
disabling recall of the migrated data using the first stub file;
generating the second stub file;
updating the first information to indicate that the stub file for the migrated data is stored in the third storage location; and
enabling recall of the migrated data using the second stub file.

14. The method of claim 11 wherein the second storage location is on a storage unit allocated to a first server and the third storage location is on a storage unit allocated to a second server distinct from the first server.

15. The method of claim 14 wherein generating the second stub file comprises:
disabling recall of the migrated data using the first stub file;
communicating a first message from the first server to the second server, the message comprising information related to the first stub file;
generating the second stub file at the second server using the information in the first message;
communicating a second message from the second server to the first server indicating generation of the second stub file; and
updating first information stored in a database to indicate that the stub file for the migrated data is stored in the third storage location, the first information indicative of the storage location of a stub file corresponding to the migrated data.

16. The method of claim 15 wherein the first stub file is deleted by the first server from the second storage location upon receiving the second message from the second server.

17. The method of claim 15 wherein the first message comprises a portion of information stored in the first stub file, the portion including an identifier indicative of the first storage location where the migrated data is stored.

18. In a storage environment wherein file data is stored in a first storage location, first data locator information that can be used to identify the location of the file data is stored in a second storage location distinct from the first storage location, a computer program product stored on a computer-readable medium for moving the first data locator information from the second storage location to a third storage location distinct from the second storage location, the computer program product comprising:
code for generating second data locator information in the third storage location, the second data locator generated based upon the first data locator information such that the file data can be recalled using the second data locator information, wherein the second data locator information is generated without recalling the file data from the first storage location;
code for enabling recall of the file data using the second data locator information without recalling the file data from the first storage location; and
code for deleting the first data locator information from the second storage location without recalling the file data from the first storage location.

19. The computer program product of claim 18 wherein the second storage location is on a storage unit allocated to a first server and the third storage location is on a storage unit allocated to the first server.

20. The computer program product of claim 19 further comprising:
code for accessing a database storing first information indicating that the file data can be recalled using the first data locator information stored in the second storage location; and
wherein the code for generating the second data locator information comprises code for updating the first information to indicate that the file data can be recalled using the second data locator information stored in the third storage location.

21. The computer program product of claim 20 wherein:
the code for generating the second data locator further comprises code for determining if the first information was updated; and
the code for enabling recall of the file data comprises code for enabling the recall of the file data using the second data locator information only if it is determined that the first information was updated.

22. The computer program product of claim 18 wherein the second storage location is on a storage unit allocated to a first server and the third storage location is on a storage unit allocated to a second server distinct from the first server.

23. The computer program product of claim 22 wherein:
the code for generating the second data locator information comprises:
code for disabling recall of the file data using the first data locator information prior to generating the second data locator information;
code for communicating a first message from the first server to the second server, the message comprising a portion of the first data locator information;
code for generating the second data locator information by the second server using the information in the first message; and
code for communicating a second message from the second server to the first server indicating generation of the second data locator information by the second server; and
wherein the code for deleting the first file locator information comprises code for deleting the first file locator information upon receiving the message from the second server.

24. The computer program product of claim 18 wherein the storage environment is managed by a hierarchical storage management (HSM) application, the file data represents migrated data, the first data locator information is stored in a first stub file, and the second data locator information is stored in a second stub file.

25. In a storage environment wherein migrated data is stored in a first storage location, a first stub file corresponding to the migrated data is stored in a second storage location, the first stub file storing information that can be used to determine the location of the migrated data, a computer program product stored on a computer-readable medium for changing the location of the stub file to a third storage location, the computer program product comprising:
code for generating a second stub file in the third storage location, the second stub file generated based upon information from the first stub file, wherein the migrated data can be recalled using the second stub file and wherein the second stub file is generated without recalling the migrated data from the first storage location; and
code for deleting the first stub file from the second storage location without recalling the migrated data from the first storage location.

26. The computer program product of claim 25 wherein the second storage location is on a storage unit allocated to a first server and the third storage location is on a storage unit allocated to the first server.

27. The computer program product of claim 26 further comprising code for accessing a database storing first information indicative of the storage location of a stub file for the migrated data, wherein the code for generating the second stub file comprises:
code for disabling recall of the migrated data using the first stub file;
code for generating the second stub file;
code for updating the first information to indicate that the stub file for the migrated data is stored in the third storage location; and
code for enabling recall of the migrated data using the second stub file.

28. The computer program product of claim 25 wherein the second storage location is on a storage unit allocated to a first server and the third storage location is on a storage unit allocated to a second server distinct from the first server.

29. The computer program product of claim 28 wherein:
the code for generating the second stub file comprises:
code for disabling recall of the migrated data using the first stub file;
code for communicating a first message from the first server to the second server, the first message comprising a portion of information stored in the first stub file;
code for generating the second stub file at the second server using the information in the first message;
code for communicating a second message from the second server to the first server indicating generation of the second stub file; and
code for updating first information stored in a database to indicate that the stub file for the migrated data is stored in the third storage location, the first information indicative of the storage location of a stub file corresponding to the migrated data; and
the code for deleting the first stub file comprises code for deleting the first stub file on the first server from the second storage location upon receiving the second message from the second server.

30. A system comprising:
a first server; and
a plurality of storage units including a storage unit storing file data in a first storage location, a storage unit assigned to the first server and storing first data locator information in a second storage location, and a storage unit assigned to the first server and comprising a third storage location distinct from the second storage location, wherein the first data locator information can be used to identify the location of the file data;
wherein the first server is configured to:
generate second data locator information in the third storage location without recalling the file data from the first storage location, the second data locator generated based upon the first data locator information such that the file data can be recalled using the second data locator information;
enable recall of the file data using the second data locator information without recalling the file data from the first storage location; and
delete the first data locator information from the second storage location without recalling the file data from the first storage location.

31. The system of claim 30 further comprising:
a database storing first information indicating that the file data can be recalled using the first data locator information stored in the second storage location; and
wherein the first server is configured to update the first information to indicate that the file data can be recalled using the second data locator information stored in the third storage location.

32. The system of claim 30 further comprising:
a second server executing a hierarchical storage management (HSM) application; and
wherein the file data represents migrated data, the first data locator information is stored in a first stub file, and the second data locator information is stored in a second stub file.

33. A system comprising:
a first server;
a second server; and
a plurality of storage units including a storage unit storing file data in a first storage location, a storage unit assigned to the first server and storing first data locator information in a second storage location, and a storage unit assigned to the second server and comprising a third storage location distinct from the second storage location, wherein the first data locator information can be used to identify the location of the file data;
wherein the second server is configured to:
generate second data locator information in the third storage location without recalling the file data from the first storage location, the second data locator generated based upon the first data locator information such that the file data can be recalled using the second data locator information; and
enable recall of the file data using the second data locator information without recalling the file data from the first storage location; and
wherein the first server is configured to:
delete the first data locator information from the second storage location without recalling the file data from the first storage location.

34. The system of claim 33 wherein:
the first server is configured to:
disable recall of the file data using the first data locator information; and
communicate a first message to the second server, the first message comprising a portion of the first data locator information;
the second server is configured to:
generate the second data locator information using the information in the first message; and
communicate a second message to the first server indicating generation of the second data locator information; and
the first server is configured to delete the first file locator information upon receiving the second message from the second server.

35. The system of claim 33 further comprising:
a third server executing a hierarchical storage management (HSM) application; and
wherein the file data represents migrated data, the first data locator information is stored in a first stub file, and the second data locator information is stored in a second stub file.

36. A system comprising:
a first server; and
a plurality of storage units including a storage unit storing migrated data in a first storage location, a storage unit assigned to the first server and storing a first stub file in a second storage location, and a storage unit assigned to the first server and comprising a third storage location distinct from the second storage location, wherein the first stub file stores information that can be used to determine the location of the migrated data;
wherein the first server is configured to:
generate a second stub file in the third storage location without recalling the migrated data from the first storage location, the second stub file generated based upon information from the first stub file, wherein the migrated data can be recalled using the second stub file; and
delete the first stub file from the second storage location without recalling the migrated data from the first storage location.

37. The system of claim 36 further comprising:
a database storing first information indicative of the storage location of a stub file for the migrated data;
wherein the first server is configured to:
disable recall of the migrated data using the first stub file;
generate the second stub file;
update the first information to indicate that the stub file for the migrated data is stored in the third storage location; and
enable recall of the migrated data using the second stub file.

38. A system comprising:
a first server;
a second server; and
a plurality of storage units including a storage unit storing migrated data in a first storage location, a storage unit assigned to the first server and storing a first stub file in a second storage location, and a storage unit assigned to the second server and comprising a third storage location distinct from the second storage location, wherein the first stub file stores information that can be used to determine the location of the migrated data;
wherein the second server is configured to generate a second stub file in the third storage location without recalling the migrated data from the first storage location, the second stub file generated based upon information from the first stub file, wherein the migrated data can be recalled using the second stub file; and
wherein the first server is configured to delete the first stub file from the second storage location without recalling the migrated data from the first storage location.

39. The system of claim 38 further comprising:
a database storing first information indicative of the storage location of a stub file for the migrated data;
wherein the first server is configured to:
disable recall of the migrated data using the first stub file;
communicate a first message to the second server, the first message comprising a portion of information stored in the first stub file;
wherein the second server is configured to:
generate the second stub file using the information in the first message; and
communicate a second message to the first server indicating generation of the second stub file; and
wherein the first server is configured to:
update the first information to indicate that the stub file for the migrated data is stored in the third storage location; and
delete the first stub file from the second storage location upon receiving the second message from the second server.
